(19) United States
(12) Patent Application Publication
(10) Pub. No.: US 2016/0019551 A1
(43) Pub. Date: Jan. 21, 2016

(54) SYSTEM AND METHOD FOR PROCESSING CUSTOMER SERVICE REQUESTS USING AN ELECTRONIC DEVICE

(71) Applicants: Mark Edward Garver, Greenville, SC (US); James Graham Hankins, Chesterfield, MI (US); Doreen Jean Hankins, Chesterfield, MI (US); Sarah Jane Wright, Ashburn, VA (US)

(72) Inventors: Mark Edward Garver, Greenville, SC (US); James Graham Hankins, Chesterfield, MI (US); Doreen Jean Hankins, Chesterfield, MI (US); Sarah Jane Wright, Ashburn, VA (US)

(21) Appl. No.: 14/800,047

(22) Filed: Jul. 15, 2015

Related U.S. Application Data
(60) Provisional application No. 62/024,519, filed on Jul. 15, 2014.

(51) Int. Cl. G06Q 30/00; H04W 4/02

(52) U.S. Cl. CPC G06Q 30/016; H04W 4/02

(57) ABSTRACT

An illustrative example system that facilitates honoring customer service requests includes a mobile station including an application that provides an indication to a user when the user is at a participating establishment where the user can use the application to request customer service through the application. A service management device is configured to receive a wireless communication from the mobile station indicating a customer service request and determine an approximate location where service is desired including identifying the participating establishment. A service request response device at the participating establishment includes a user interface that is configured to provide information regarding the request to allow an appropriate individual to respond to the request. The service request response device provides an indication of the acknowledgement to the service management device. The service management device is configured to communicate an indication of the acknowledgement to the customer.

### CROSS REFERENCE TO RELATED APPLICATIONS

This application claims priority to U.S. Provisional Application No. 62/024,519, which was filed on Jul. 15, 2014.

### BACKGROUND

There are a variety of situations in which an individual customer may require assistance or service from an employee or representative of a business establishment. For example, customers in a restaurant often require attention from their server at various points during their meal. The customer typically has to get the server's attention when the server is within view. At times, this process can be frustrating for an individual especially if their particular need requires immediate attention and their server is particularly busy in another portion of the restaurant. Another example situation may occur in a relatively large retail store when a customer needs assistance in a particular aisle and does not see any employees for several minutes. The customer typically has to wander about the store to locate someone who can provide the required assistance. This can be annoying and typically increases the amount of time it takes for the individual to complete their intended shopping.

There are a variety of situations like those described above. It is not possible in many situations to increase the number of employees to minimize customer wait time for a response. Businesses could benefit if their customers had improved service experiences.

### SUMMARY

An illustrative example system that facilitates honoring customer service requests includes a mobile station including an application that provides an indication to a user when the user is at a participating establishment where the user can use the application to request customer service through the application. A service management device is configured to receive a wireless communication from the mobile station indicating a customer service request and determine an approximate location where service is desired including identifying the participating establishment. A service request response device at the participating establishment includes a user interface that is configured to provide information regarding the request to allow an appropriate individual to respond to the request. The service request response device provides an indication of the acknowledgement to the service management device. The service management device is configured to communicate an indication of the acknowledgement to the customer.

Various features and advantages of at least one example embodiment will become apparent to those skilled in the art from the following description. The drawings that accompany the description can be briefly described as follows.

### BRIEF DESCRIPTION OF THE DRAWINGS

FIG. 1 schematically illustrates a system for processing customer service requests.

FIG. 2 schematically illustrates how the example embodiment of FIG. 1 may be implemented in a restaurant setting.

FIG. 3 is a flow chart diagram summarizing an example method designed according to an embodiment of this invention.

FIG. 4 schematically illustrates how the embodiment of FIG. 1 may be used in a retail setting.

FIG. 5 schematically illustrates an embodiment where the system is utilized for facilitating customer service at a variety of business establishments.

### DETAILED DESCRIPTION

Embodiments of this invention facilitate customer service requests by allowing a customer to indicate a desire for service using an application on a mobile station, such as a smart phone. The application on the mobile station provides notifications when an individual is near or in a participating business establishment and presents appropriate options to the individual to request assistance or service. The request is processed by a service management device, such as a cloud based system, and sent to an appropriate individual with an indication of the customer's location. The customer experiences more convenience and better service while the individual or business providing the service experiences improved efficiencies.

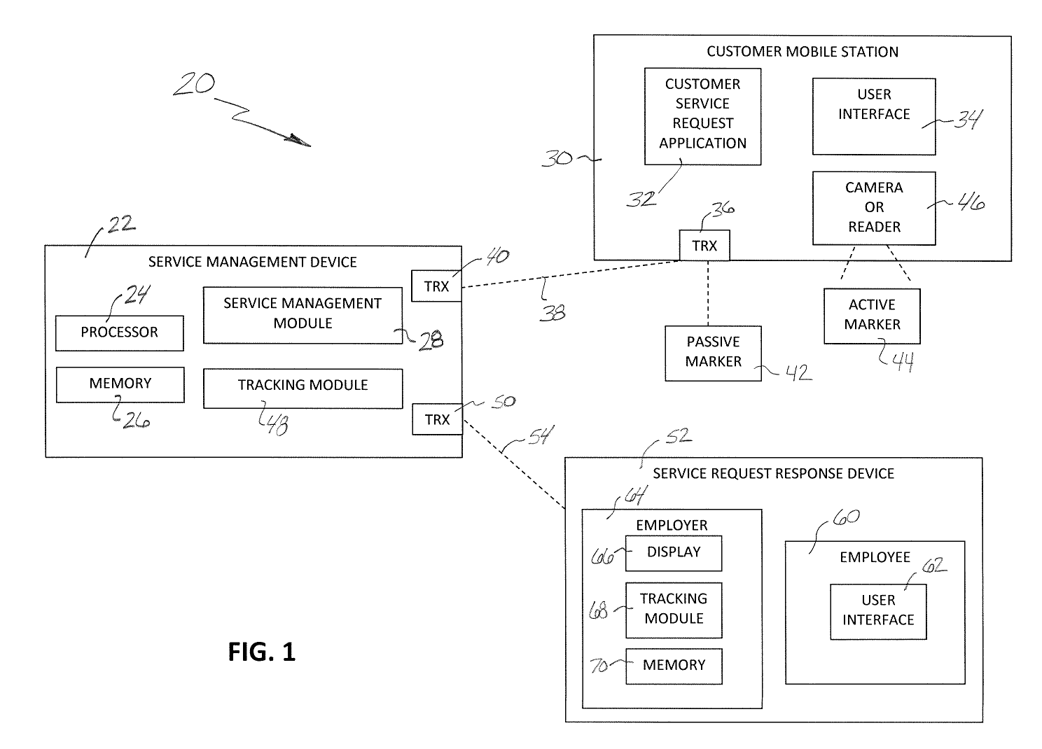

FIG. 1 schematically illustrates an example system 20 for facilitating customer service requests. A service management device 22 is configured to receive customer service requests, report them to an appropriate individual at a business establishment and process information regarding the requests and responses to those requests. The service management device 22 in this example is realized using at least one computing device including a processor 24 and a memory 26 associated with the processor. The memory 26 in this example is used to at least temporarily store information regarding customer service requests. The memory 26 also may include instructions executable by the processor 24 for performing the various functions of the service management device 22.

The service management device 22 is schematically represented as a single device or unit for discussion purposes. One or several computing devices may be used as the service management device 22. In one example, the service management device 22 is a cloud-based system (e.g., one or more virtual machines) that includes appropriate computer programming for facilitating responses to customer service requests. In another example, the service management device is a dedicated server device. Those skilled in the art who have the benefit of this description will realize what combination of hardware, software and firmware will best meet their particular needs to realize a service management device 22.

The service management device 22 includes a service management module 28 that includes programming so that the service management device 22 is configured to process information regarding customer service requests. The service management module 28 is configured to process a customer service request and determine at least an approximate location where the requested service is desired. In the example of FIG. 1, the customer service request is made through a wireless communication from a mobile station 30, which may be a smartphone or a tablet device for example.

The mobile station 30 in most implementations belongs to the individual customer. The mobile station includes a customer service request application 32 that includes programming to allow a customer to use a user interface 34 to place a request for assistance or service. The application 32 may be stored in memory that is part of the mobile station device and the application 32 may be executed by a processor of the mobile station. The mobile station 30 includes a transceiver 36 that is configured to communicate over a wireless link 38 with the service management device 22. The service management device includes a transceiver 40 configured for communications with the mobile station 30. While not specifically illustrated, the wireless communication from the mobile station 30 may be first to a local access point and then relayed to the service management device. Alternatively, direct communication between the mobile station 30 and the service management device 22 may be used. Communications between the access point and the service management device 22 may occur over a wireless link, a landline, Internet connection, or a combination of these.

In the example of FIG. 1, there are location markers 42 and 44 that facilitate identifying a location of the mobile station 30 so that the individual customer may be located for providing the requested service. In this example, the location marker 42 is considered a passive location marker because the customer is passive when the marker 42 is used. An example of a passive marker 42 includes a wireless signaling beacon that communicates with the mobile station 26 in a manner that allows the customer application 32 to make a determination regarding a distance between the mobile station 30 and the passive marker 42. Known beacon technologies are used in one such example. Other location markers that do not require any particular input from the customer may be used in some implementations.

When the position of a location marker 42 is known, at least one characteristic of a signal received by the mobile station 30 from the marker can be utilized to make a location determination using a known technique. While only one passive location marker 42 is illustrated, some example systems will include multiple markers that are collectively used to provide an indication of the position or location of the mobile station 30. For example, where multiple markers 42 are situated near the mobile station 30, the mobile station 30 may detect a stronger signal from the closest of the markers 42 and that signal strength is a characteristic that may be used by the service management module 28 to determine the location where service is desired. In another example, triangulation techniques are used with information regarding multiple location marker signals received or detected by the mobile station 30 to determine the location where service is desired. Providing a location where service is desired facilitates a more rapid response to the customer request.

The location marker 44 is considered active for discussion purposes because it is a type of location marker that requires or involves some user input or action to either initiate location determination or to confirm a location. In the illustrated example, the location marker 44 includes an image that contains information that can be recognized by the service management module 28 as associated with a particular location. For example, the image includes a bar code or scan code that the customer's mobile station 30 is capable of reading or imaging through a camera or reader 46. The customer application 32 communicates appropriate information to the service management device 22 regarding the location marker 44 for providing an indication regarding the location of that mobile station 30 for a particular visit to that establishment.

The service management device 22 in this example also includes a tracking module 48 that is configured to at least temporarily track customer requests that are received by the device 22 and processed by the service management module 28. The tracking module in this example maintains a variety of information pertaining to received requests. The information tracked by the tracking module 48 is available in real time to provide a current status regarding an individual's or a business' use of the system. The type of information maintained by the tracking module 48 includes pending requests, any customer identification information associated with any pending request, average number of requests by time interval, average number of visits, average time to resolution of requests, average number of requests by location, and average customer satisfaction rating information. The tracking module 48 in this example associates such information with the records regarding the corresponding request.

The information maintained by the tracking module may be stored in the memory 26 and may be used by a business owner or manager to evaluate customer satisfaction, employee effectiveness, etc. In some embodiments, the tracking module 48 maintains information for individual customers. By utilizing the customer application 32, an individual may access information regarding previous visits to various businesses including, for example, response times to service requests placed through the application 32 and any comments the individual may have entered regarding a particular business or its quality of service. Such information may be useful in helping an individual make decisions on where to shop for a particular item or where to eat given time constraints or particular food preferences.

The service management device 22 includes a transceiver 50 configured to communicate information regarding customer service requests to a service request response device 52 over a link 54, which may be a wireless link, an Internet connection or other communication link. The service request response device 52 communicates with the service management device 22 regarding any request and any response to the customer request.

The service request response device 52 in the illustrated example includes an employee portion 60, which may be a mobile station, such as a smart phone or tablet, that may be carried about by an appropriate individual at a business establishment to receive notification of service requests and to input information regarding responses to those requests. The employee portion 60 includes a user interface 62, such as a touch screen, that provides an indication of the customer request(s), a type of service requested (if applicable or available), an indication of the location where service is desired, and an ability for the user or employee to enter an acknowledgment of the request. One example includes various screen display options that may be selected to indicate an acknowledgement. Multiple employee portions 60 may be included as part of the service request response device 52 with each of them being given to a particular individual for use during a particular shift, for example.

The service request response device 52 communicates the acknowledgement to the service management device 22. In this example, the service management device communicates an indication of the acknowledgment to the customer. The mobile station 30 may show an acknowledgment on the user interface 34 so the customer knows that someone is aware of the request.

The service request response device 52 in this example includes a business or manager portion 64 that has administrative and notification features to provide information to an appropriate individual at a business establishment regarding the customer service request. This example includes a display device 66 that provides a master display to a manager or business owner, for example, regarding all requests that are handled by the service management device 22 on behalf of that particular establishment. The display device 66 in this example provides a real time, dynamically updated, status of all requests currently pending in the system with ongoing collective information over a selected window of time, such as the current day or shift.

In some examples, the employer portion 64 is configured to allow an authorized individual to assign a customer request to a particular individual for a response. In other examples, the request is automatically assigned to an appropriate individual depending on information regarding who is assigned to a service area including the location of the request or based on another appropriate criterion.

In the illustrated example, the employer portion 64 includes a tracking module 68 that maintains information regarding customer service requests for that business entity. The tracking module 68 may be used in place of the tracking module 48 or in addition to it, depending on the configuration of the particular implementation. The tracking module 66 in this example includes information like that maintained by the tracking module 48 described above. The information regarding tracked requests may be stored in local memory 70 or in an offsite memory.

In embodiments in which the service management device 22 is implemented as a cloud-based system, at least the display device 66 may be a portion of any device that an authorized individual has registered or otherwise associated with the system 20 so that the authorized individual has access to the information regarding use of the system from any location and at any time. The ability to access such information through a cloud-based service management device 22 provides significant flexibility and convenience to an owner or manager of a business establishment for monitoring various aspects of customer service and customer satisfaction. Additionally, any pressing our current concerns can be more efficiently addressed when the pertinent information is available at essentially any location where access to the cloud based service management device is possible.

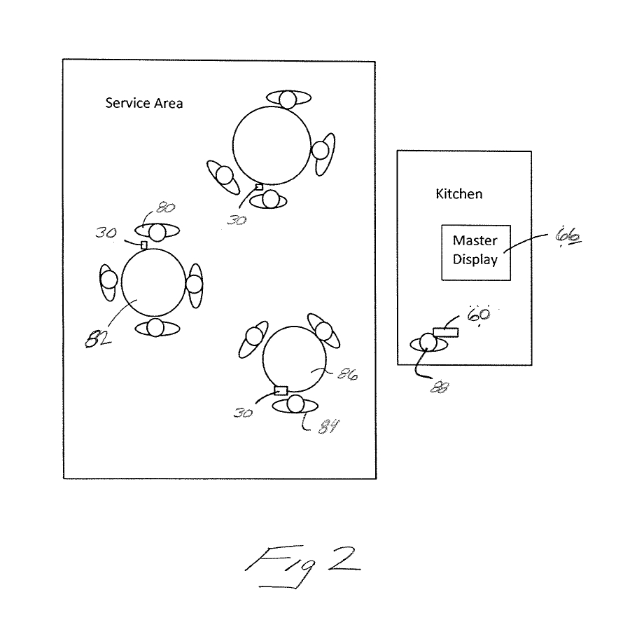

FIG. 2 schematically illustrates an example situation in which the system of FIG. 1 may be used. FIG. 2 schematically illustrates a restaurant including a service area where customers may be seated at tables. In this example, a customer 80 has a mobile station 30 that includes the application 32 to allow the customer 80 to place requests for service. The system determines that the customer 80 is seated at the table 82 based upon one of the location techniques mentioned above. Another customer 84 has a mobile station 30 that includes the application 32. The customer 84 is seated at a table 86 and the service management device 22 is capable of identifying differences in location between the tables 82 and 86 based upon the manner in which the location markers or beacons have been situated within the restaurant establishment. The example of FIG. 2 includes a master display 66 within a kitchen area that may be used by a restaurant manager for monitoring any or all service requests that are placed by customers utilizing their mobile station or smart phone. In FIG. 2, an employee 88, such as a waiter, has a mobile notification device 60 for receiving notification of customer service requests. The individual 88 may use the device 60 to respond to the request, to provide an acknowledgement to the customer, and to indicate when and how the request was fulfilled.

The owner or operator of the restaurant schematically shown in FIG. 2 subscribes for service through an appropriate service provider. The business owner in some examples provides a number of points of interest that would be appropriate for the particular business establishment. For example, the restaurant owner may wish to divide the service area by particular tables or particular zones. The service provider may assist the restaurant owner in determining how best to arrange the markers or beacons for identifying particular locations of customers. For example, individual tables may have a bar code or scan code situated on the table or on some display marker located on the table to facilitate identifying the particular table where a particular customer is located during that visit. Once the appropriate markers or location beacons have been installed, they may be associated with appropriate points of interest and that information is provided to the service management device 22 for configuring responses and notifications regarding service requests.

Once all of the appropriate location markers have been installed, the master display 66 has been situated in a desired location and any mobile devices 60 have been configured, it becomes possible for the business establishment to utilize the system for providing enhanced customer service.

The individual customers in some examples download the location or service request application 32 on their mobile station 30. The customer may be provided with options such as receiving a notification when they arrive at a business establishment that is a subscriber to the service. In a situation where the individual with the mobile station 30 approaches a participating business, the application 32 may provide a notification on the mobile station 30 regarding the possibility for using the system to request service. In some examples, the application 32 sends a notification to the service management device 22 that a customer having the capability to utilize the system is approaching or has arrived. The service management device 22 provides a corresponding notification to the business through the service request response device 52.

In some examples, the application 32 presents a welcome screen to the customer as they approach or enter the business facility and may present information regarding particular sale items or specials that are available at that time.

Once the customer has entered the establishment, locating the mobile station 30 through one of the example processes described above may begin. Assuming at some time during the customer's visit to that restaurant they require attention from the server, the customer may utilize the application 32 to request service. The request is received by the service management device 22 and reported to the service request response device 52. In some examples, a timer is initiated once the notification for service has been sent. The display 66 and the device 60 provide visual and perhaps audible notifications regarding the requested service.

The tracking modules 48 and 68 in this example save information regarding each request and information regarding timing for responding to the request. In the case of FIG. 2, the individual with the device 60 provides an acknowledgement to a request that is then communicated to the individual customer on the display 34 of the mobile station 30. The acknowledgement may be an indication that the request has been received and that the server is approaching. The tracking modules 48 and 68 record the timing between the notification and the acknowledgment of the request. Once the server arrives at the appropriate table and addresses the customer's request, the server may enter information regarding completing the request and providing the desired service. The tracking modules 48 and 68 track the amount of time between service request and completion and provide reports on a schedule selected by the business owner (e.g., hourly, daily, monthly). In some examples, the application 32 presents an option to the customer to acknowledge that service was received. The customer may also be provided with the option of entering any comments regarding their satisfaction with the offered service.

In some examples, the service management device 22 includes the capability of storing information regarding particular customers to identify customer preferences and communicating that information to the business establishment, which may be useful for providing enhanced, personalized customer service during future visits.

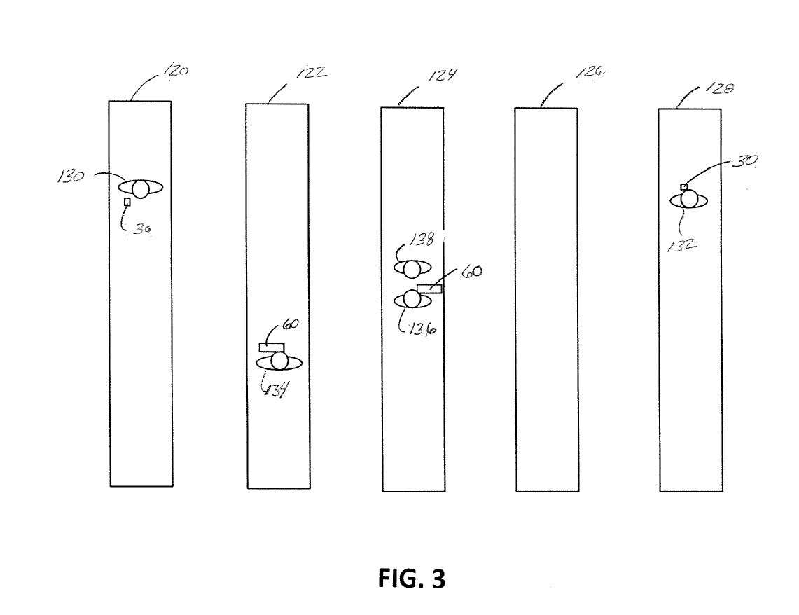

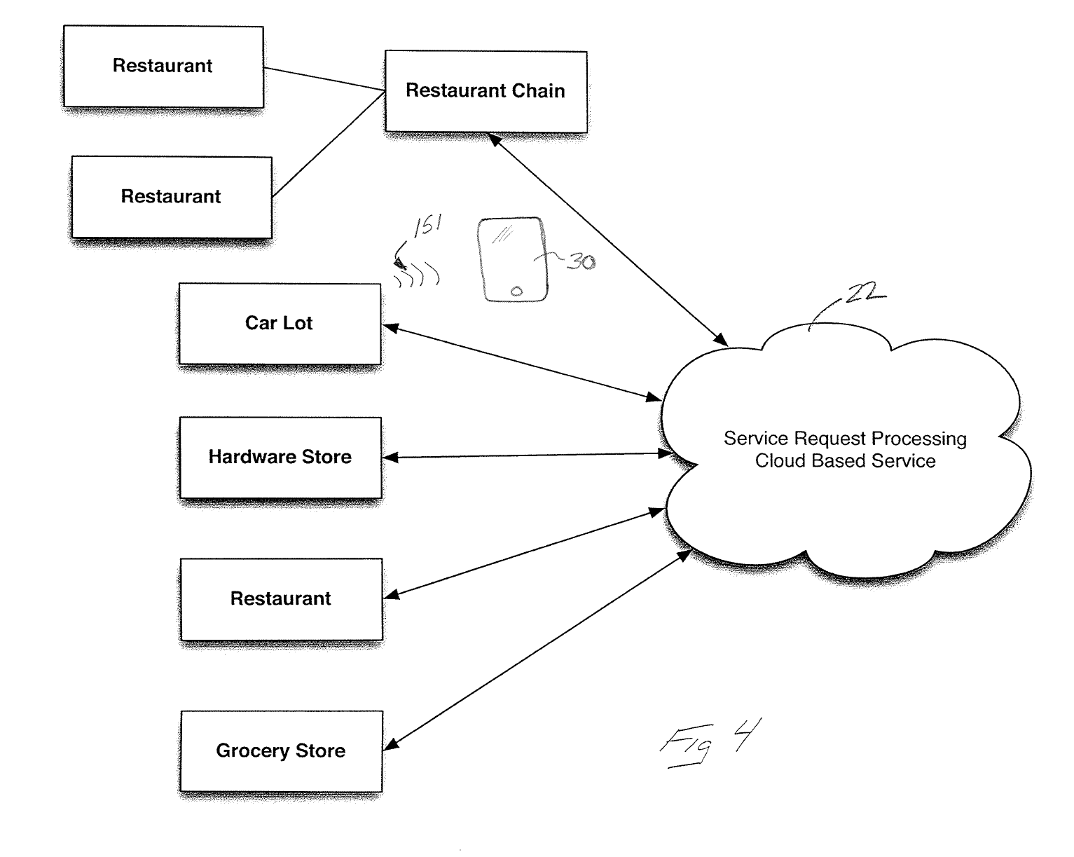

FIG. 3 schematically illustrates another scenario in which the system of FIG. 1 may be useful. FIG. 3 schematically illustrates a retail establishment having different sections or aisles 120, 122, 124, 126 and 128. Individual customers 130 and 132 each have a mobile station 30 upon which the application 32 has been stored so that those customers may request service while they are in the store schematically shown in FIG. 4. The two employees 134 and 136 have devices 60 to provide those employees notification regarding any received customer request. In the scenario shown in FIG. 3, the employee 136 is assisting a customer 138. Therefore, the employee 136 may, through the device 60, decline to respond to a request received from the customer 130 or 132. The employee 134 will receive notification of the customer request and may receive notification that the employee 136 has declined that request because the employee 136 is busy with the customer 138. Assuming each of the customers 130 and 132 request assistance, the employee 134 may use the device 60 to provide an acknowledgement to the customer 132 indicating that the employee will be there shortly. Given that the employee 134 is located relatively closer to the customer 130, the employee 134 may approach that customer without having to provide an acknowledgement through the device 60. On the other hand, the employee 134 may be required to provide an acknowledgement through the device 60 for tracking the quality of service over time at that store. The locations of the individual customers in the example of FIG. 4 may be obtained using beacons or wireless signaling technologies or through bar codes or scan codes that are presented to the customers in the different sections or aisles of the store.

FIG. 4 shows how the example system 20 may be used for a variety of business establishments. The service management device 22 is cloud based in the example of FIG. 4. A variety of business owners are participants in the network provided by the service provider that operates the service management device 22. The service management device memory 26 includes a database or listing of participating establishments, their locations and other information regarding each such establishment. Each of the establishments schematically represented in FIG. 4 may have customized point of interest identifiers and configurations. Each of the establishments may have customized service request response devices 52 for providing notifications and other information to the business establishment according to their particular needs. In this example, individual mobile station owners (e.g., customers) and participating businesses can be considered subscribers of the service provider that operates the server management device 22.

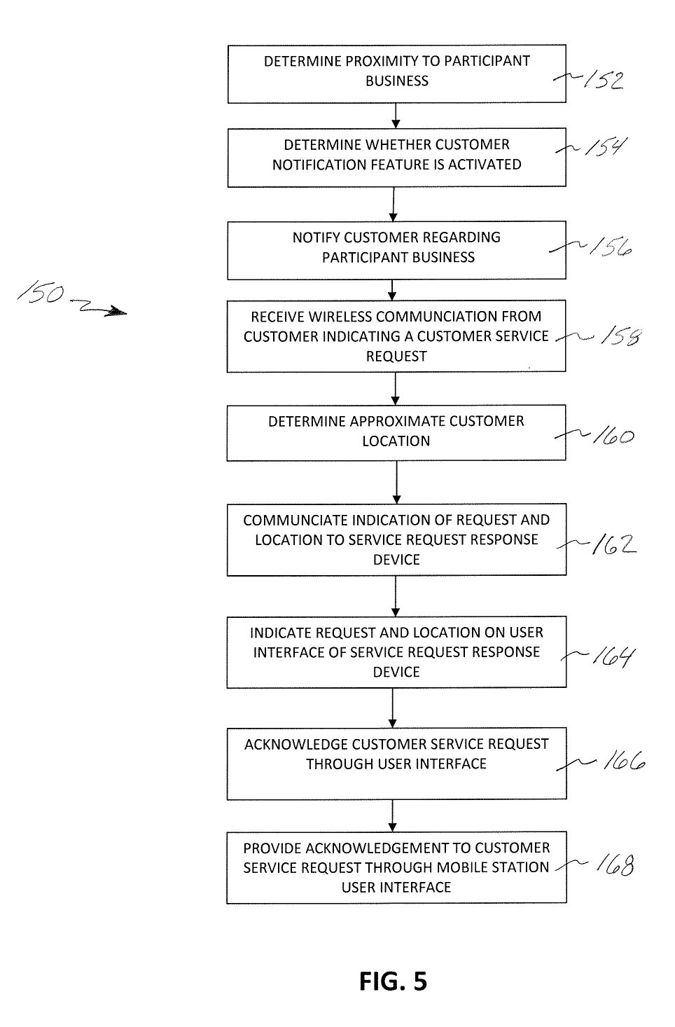

FIG. 5 is a flow chart diagram 150 summarizing an example approach to facilitating customer service requests. At 152 the customer application 32 is operative in cooperation with signal detecting or location determining capabilities (e.g., GPS) of the mobile station 30 to determine that the mobile station (and its owner) is near or has entered a business that is a part of the network including the service management device 22. In some embodiments, the locations of the participating businesses are available for the application 32 to compare with a current location of the mobile station 30. In other embodiments, participating establishments will have a beacon signal (an example is shown schematically at 151 in FIG. 4) near the entry or other suitable location that is detectable by the mobile station 30 and recognizable through operation of the application 32 as an indicator that the current location includes a network participant.

At 154, the application 32 determines whether notifications should be provided on the user interface 34 (e.g., an image on a screen display, an audible indicator, or a combination these). In this example, the application 32 provides different “do not disturb” (DND) options. One such option allows the customer to avoid receiving information through the application 32 when the individual does not wish to be bothered or otherwise does not desire to take advantage of the features available through the application 32. For example, the individual may not wish to be notified when entering a participating business. In the example of FIG. 5, the application 32 checks this type of “do not disturb” status at various times when a potential notification may be sent to the mobile station 30 even if not specifically illustrated in the flowchart diagram.

Another do not disturb feature in the example embodiment allows the customer to provide an indication to the employees or service personnel at a restaurant that the individual does not wish to be disturbed. In one such embodiment there is a button presented on the user screen while the application 32 is active that, when toggled, changes the screen to a DND screen. The user can then place the mobile station 30 where it can be seen by others nearby. The application 32 disables or overrides any screen saver so the DND stays displayed. The screen provides notice to the server that the customer desires privacy or at least does not want to be interrupted.

In some embodiments, the do not disturb feature includes communicating this desire to the service request response device 52 and the appropriate individual(s) are notified through a user device 60, for example.

The determination at 154 in this example is that the customer desires notifications. At 156 the customer is notified and once the customer realizes that the application 32 can be useful, he places a request for assistance or service. The service management device 22 receives that request at 158 and it is processed by the service management module 28 at 160. The request is processed to determine where assistance or service is desired including determining the participating business establishment and where in that particular establishment the customer is situated. In this example the customer location is determined from information included with the initial request although the request and the location information need not be part of the same wireless communication.

At 162 the service management device 22 provides an indication of the request and the customer location to the appropriate service request response device 52. At 164, the service request response device 52 provides an indication of the request and customer location on the user interface 62. At 166 the appropriate individual provides an acknowledgment of the request.

Assuming that the customer has not deactivated the notification feature, at 168 the service management module 28 processes the response and communicates an indication of the acknowledgement to the mobile station 30 where an indication of the acknowledgement is provided on the user interface 34 so that the customer at least knows that the request has been received. In some examples, the acknowledgement itself or a subsequent notification provides the customer with more detailed information, such as an expected wait time for an actual response to the request, information about the individual who will provide the requested service, or the manner in which the response will be provided.

As can be appreciated from the preceding description, a customer has the ability through the application 32 to make requests for service or assistance at a variety of types of businesses or other establishments. By utilizing the application 32 and being a subscriber, an individual can be informed which businesses in a local area are also network participants. The customer can customize their experience through options provided by the application 32, such as selecting which businesses or business types are of interest, selecting the do not disturb function mentioned above and various other options for types or formats of notifications.

The example system facilitates customer service in a more efficient and more consistent manner, which enhances the customer's experience and enables the business owner to determine how effectively customer service requests are being honored.

The preceding description is illustrative rather than limiting. Variations and modifications to the disclosed example embodiments may become apparent to those skilled in the art that do not depart from the essence of this invention. Some features may have been described or illustrated in a particular combination but they are not limited in that way. Other combinations of selected ones of the disclosed features or aspects of the example embodiments are possible to realize other embodiments. The scope of legal protection afforded to this invention can only be determined by studying the following claims.

We claim:

1. A system that facilitates customer service requests, comprising
a mobile station including an application, the mobile station being configured through the application to
notify an individual when the mobile station is at one of a plurality of participating establishments,
provide an option to the individual to make a customer service request through the mobile station while at the participating establishment, and
to wirelessly transmit a customer service request from the mobile station;
a service management device comprising:
at least one processor;
memory associated with the at least one processor; and
a service management module configured to
process a wireless communication from the mobile station indicating the customer service request, and
determine an approximate location where the requested service is desired including identifying the participating establishment;
and
a plurality of service request response devices configured to communicate with the service management device, the service request response devices respectively including a user interface that is configured to
provide an indication of the customer service request,
provide an indication of the approximate location where the service is desired, and
provide the user an ability to enter an acknowledgement of the customer service request;
wherein the service management device communicates with a service request response device associated with the participating establishment to provide notice of the customer service request to an appropriate individual at the participating establishment and the associated service request response device provides an indication of the acknowledgement to the service management device.

2. The system of claim 1, wherein the service management device is configured to communicate an indication of the acknowledgement to the customer.

3. The system of claim 1, comprising
at least one location marker that provides an indication of a position of the marker, the indication being useful to a customer mobile station for providing an indication of the approximate location where the service is desired as part of the communication indicating the customer service request.

4. The system of claim 3, wherein
the at least one location marker comprises a visible image that includes information regarding the position of the marker;
the information is included in the wireless communication from the customer; and
the service management device is configured to interpret the information regarding the position of the marker to determine the approximate location where the requested service is desired.

5. The system of claim 3, wherein
the at least one location marker comprises at least one beacon device that emits a beacon signal;
the wireless communication includes at least one characteristic of the beacon signal; and
the service management device is configured to use the at least one characteristic of the beacon signal for determining the approximate location where the requested service is desired.

6. The system of claim 1, wherein the application provides a user with an option to have the mobile station display a do not disturb indicator on the mobile station that is configured to communicate the user's desire not to be disturbed to another at the participating establishment.

7. The system of claim 1, wherein the service request response device comprises a mobile station.

8. The system of claim 1, comprising a tracking module configured to at least temporarily provide information regarding tracked customer service requests including an indication of a status of the tracked customer service requests.

9. The system of claim 8, wherein the tracking module is configured to provide one or more of
an indication of currently pending customer service requests;
an indication of a response time to each tracked customer service request;
an identifier of a customer associated with at least some of the tracked customer service requests;
an indication of customer feedback associated with at least some of the tracked customer service requests;
an identifier of the user assigned to each of the tracked customer service requests; and
an indication of user comments regarding at least some of the tracked customer service requests.

10. The system of claim 1, wherein the application is configured to allow a user to select not to receive indications regarding proximity to a participating establishment or information regarding pending customer service requests.
